(19) United States
(12) Patent Application Publication
(10) Pub. No.: US 2012/0164032 A1
(43) Pub. Date: Jun. 28, 2012

(54) SYSTEMS, DEVICES AND METHODS FOR CALCIUM LOOPING

(75) Inventor: Alex Wormser, Marblehead, MA (US)

(73) Assignee: WORMSER ENERGY SOLUTIONS, INC., Marblehead, MA (US)

(21) Appl. No.: 13/394,150

(22) PCT Filed: Sep. 20, 2010
(86) PCT No.: PCT/US10/49522

§ 371 Date: Mar. 4, 2012

Related U.S. Application Data
(60) Provisional application No. 61/243,906, filed on Sep. 18, 2009.
(60) Provisional application No. 61/243,687, filed on Sep. 18, 2009.
(60) Provisional application No. 61/244,035, filed on Sep. 19, 2009.
(60) Provisional application No. 61/365,187, filed on Jul. 16, 2010.

(30) Foreign Application Priority Data
Dec. 23, 2009 (US) PCT/US2009/069455

(51) Int. Cl. B01D 53/04; B23P 17/00

(52) U.S. Cl. 422/162; 29/401.1

(57) ABSTRACT

An exemplary adiabatic calcium looping system includes a first fixed-bed reactor having a fixed sorbent bed holding a calcium-based sorbent, and a second fixed-bed reactor having a fixed sorbent bed holding a calcium-based sorbent. The exemplary system includes valve mechanisms for alternately configuring each of the first and second reactors in a carbonator configuration and a calciner configuration. The first reactor is configured in the carbonator configuration when the second reactor is configured in the calciner configuration, and the first reactor is configured in the calciner configuration when the second reactor is configured in the carbonator configuration.

### RELATED APPLICATIONS

This application claims the benefit of, and priority to, U.S. Patent Application Ser. No. 61/243,687, filed Sep. 18, 2009, entitled “Coal Gasification,” U.S. Patent Application Ser. No. 61/243,906, filed Sep. 18, 2009, entitled “Pressure-Swing Calcium Looping (PSCL),” U.S. Patent Application Ser. No. 61/244,035, filed Sep. 19, 2009, entitled “Calcium Looping,” U.S. Patent Application Ser. No. 61/365,187, filed Jul. 16, 2010 and entitled “Carbon Capture System for Airblown Integrated Gasification Combined Cycles,” and International (PCT) Patent Application Serial Number PCT/US2009/069455, filed Dec. 23, 2009, entitled “Mild Gasification Combined-Cycle Powerplant.” This application is also related to International (PCT) Patent Application Serial Number PCT/US2008/067022, filed Jun. 13, 2008, entitled “Mild Gasification Combined-Cycle Powerplant.” The entire contents of these applications are incorporated herein in their entirety by this reference.

### SUMMARY

Exemplary embodiments relate to reducing carbon dioxide (CO₂) emissions from power plants, and in particular, coal-fired power plants using calcium looping technologies. More specifically, exemplary embodiments provide systems, devices and methods for implementing adiabatic calcium looping technologies to reduce the carbon content in a syngas using a calcium-based sorbent residing in fixed sorbent beds. Exemplary embodiments may be used to produce chemicals from syngas.

Calcium looping is a process whereby a calcium-based sorbent produced from a mineral containing calcium carbonate is used to remove carbon compounds in a gas. Calcium looping may be used to substantially reduce the carbon dioxide emissions in the stack gases from a power plant or other systems that use fossil fuels. The sorbent is generally produced from limestone or other mineral whose chemically-active constituent is calcium carbonate. Limestone is an inexpensive material whose low cost reduces the durability requirements for the sorbent. The term “looping” refers to the fact that the calcium looping process is reversible, so the sorbent can be regenerated. Carbon capture is an element in the process called “carbon capture and sequestration” (CCS), in which the captured carbon dioxide is piped to an underground reservoir for permanent storage.

When used with the systems described in the referenced application to, for example, repower existing coal plants to convert them into integrated gasification combined cycle (IGCC) plants, calcium looping is used in the pre-combustion mode in which it treats the fuel before it is fired.

In an exemplary elementary embodiment, calcium looping is implemented using two reactors: a carbonator in which carbon compounds are removed from a syngas by a calcium-based sorbent, and a calciner in which a stream of carbon dioxide is emitted from the sorbent, which regenerates the sorbent. The carbon dioxide stream emitted from the sorbent is suitable for sequestration. Each reactor includes a fixed bed in which the sorbent is stationary. The function and configuration of each reactor is periodically changed. For example, the reactor that was serving as a carbonator is changed to being a calciner and, at substantially the same time, the reactor that was serving as a calciner is changed to being a carbonator. This changeover of configuration and function is accomplished by the switching of valves that control the gas flows to and from the reactors. During changeover, each reactor is depressurized to limit the contamination of the gases emerging from the reactors.

Calcium looping is a high-temperature process in which the sorbent-enhanced reaction (SER) occurs. Steam reacts with the carbon monoxide in the water-gas shift reaction to form carbon dioxide and hydrogen. The carbon dioxide formed is promptly removed from the syngas by the action of the sorbent, which enables the sorbent to react at a much higher temperature than would be possible in its absence. High-temperature operation increases both the plant efficiency and carbon capture efficiency, and reduces the capital cost.

In adiabatic calcium looping, the heat required for calcination is provided by the sensible heat of the structure containing the sorbent, causing the sorbent structure to cool during calcination. The heat is then restored by the sensible heat of the sorbent structure provided by carbonation. Exemplary ACL systems thereby avoid the need to add or remove heat during carbon capture. Exemplary ACL systems thus eliminate the need for external heat sources that provide heat during carbon capture and external heat sinks that remove heat during carbon capture. The sorbent structure contains both the chemically-active sorbent and any other suitable material making up the structure, including one or more chemically-inactive materials that are in thermal contact with the chemically-active elements of the sorbent.

Adiabatic calcium looping is a pressure-swing process, which means that the carbonator operates at high pressure and the calciner operates under a vacuum formed at the inlet of a compressor.

Adiabatic calcium looping requires that carbonation occur at a vapor pressure of the CO₂ in the syngas that is significantly higher than the partial-pressure-curve of the sorbent, whereas calcination occurs in a vacuum below the partial-pressure curve.

In an optimal condition, the temperature range at which adiabatic calcium looping is allowed to occur is restricted to a narrow window.

In an exemplary embodiment, calcium looping is combined with steam methane reforming, whereby the concentration of both carbon-containing gases, methane and carbon monoxide, in the syngas, are both reduced significantly.

In an exemplary embodiment, carbonation and calcination both occur in fixed-bed reactors, whereby the sorbent material remains stationary. At any time, one of the reactors serves as a carbonator and the other serves as a calciner. Before the sorbent in the carbonator is fully saturated, the valving to the reactors is changed so that the reactor that had been configured to operate as a carbonator is now configured to operate as the calciner, and the reactor that had been configured to operate as the calciner is now configured to operate as the carbonator. The cycle may be repeated any number of times or indefinitely. In the context of the sorbent, the term “fully saturated” means that the sorbent is no longer effective at fully removing the carbonaceous gases from the syngas, a process that is also known as “breakthrough.”

The process by which the configurations and functions of the reactors are reversed by the changing of valve positions, is called “changeover”. In an exemplary embodiment, both reactors are decompressed to a vacuum as part of the changeover process to minimize the contamination of the gases after the changeover is completed.

In an exemplary embodiment, the bed in the reactors contain the sorbent in a composite structure having an outer portion and an interior portion. The outer portion of the composite sorbent structure, e.g., the outer surface, may contain the calcium-based sorbent. The interior portion of the composite sorbent structure, e.g., the core or substrate, may contain a material whose primary function is to serve as a heat sink to the outer portion of the composite structure. The heat sink controls the magnitude of the temperature swing from carbonation to calcination, thereby enabling the system to operate at its optimal efficiency.

In an exemplary embodiment, the outer portion of the composite sorbent structure contains a cement, such as calcium aluminate cement, to increase both the reactivity of the sorbent and the stability of its reactivity. In an exemplary embodiment, the interior portion of the composite sorbent structure contains a cement, such as calcium aluminate, whose high density and high specific heat both serve to minimize the size and cost of the reactor. The cement is also strong, adding to the structural stability of the bed in the reactor.

In an exemplary embodiment, a mixture of sorbent and cement are contained in the interior portion of the composite sorbent structure to increase the stability of the system over time if the reactivity of the surface sorbent varies with cycling. In another exemplary embodiment, the compositions of the outer and interior portions are matched to provide for maximum adhesion between the two outer and interior portions. In another embodiment, a brazing alloy is used to attach the sorbent outer portion to the interior portion of the composite sorbent structure.

In an exemplary embodiment, the composite sorbent structures are in the form of pebbles or pellets. In another exemplary embodiment, the composite structures are in the form of rods. In both exemplary embodiments in which the sorbent is provided as pellets or rods, mechanical structures are provided to bear the weight of the material in the fixed bed, thereby reducing the forces on the sorbent created by the weight of the bed.

In an exemplary embodiment, the bed in the reactors contain a catalyst that enables the methane in the syngas to be converted into a carbonaceous gas that can then be carbon-captured.

In accordance with one exemplary embodiment, an adiabatic calcium looping system is provided for reducing the carbon content in a syngas. The exemplary system includes at least one fixed-bed reactor having a fixed sorbent bed. The reactor is alternately configured in a pressurized carbonator configuration and a sub-atmospheric pressure calciner configuration. A calcium-based sorbent resides in the fixed sorbent bed of the reactor for adsorbing the carbon in the syngas when the reactor is configured in the carbonator configuration, and for desorbing the carbon dioxide when the reactor is configured in the calciner configuration. The exemplary system includes one or more valve mechanisms for alternately configuring the reactor in the carbonator configuration and the calciner configuration.

In operation, the exemplary reactor is configured in the carbonator configuration by the valve mechanisms. During one time period, the reactor, configured in the carbonation configuration, operates as a carbonator in which carbonation takes place. During carbonation, the calcium-based sorbent in the fixed sorbent bed adsorbs carbonaceous gases in the syngas. Before the sorbent in the fixed sorbent bed of the reactor reaches a saturation level, a changeover takes place in which the exemplary reactor is configured in the calciner configuration by the valve mechanisms. During a subsequent time period, the reactor, configured in the calciner configuration, operates as a calciner in which calcination takes place. During calcination, the sorbent desorbs the carbon dioxide. The valve mechanisms subsequently repeats the above cycles. In an exemplary embodiment, the valve mechanisms may periodically configure the reactor to alternate between the carbonator and calciner configurations.

In accordance with another exemplary embodiment, an adiabatic calcium looping system is provided for reducing the carbon content in a syngas. The exemplary system includes a first fixed-bed reactor having a first fixed sorbent bed holding a calcium-based sorbent, and a second fixed-bed reactor having a second fixed sorbent bed holding a calcium-based sorbent. The first reactor is alternately configured in a pressurized carbonator configuration and a sub-atmospheric pressure calciner configuration and the second reactor is alternately configured in a pressurized carbonator configuration and a sub-atmospheric pressure calciner configuration, such that the first reactor is in the carbonator configuration when the second reactor is in the calciner configuration and the first reactor is in the calciner configuration when the second reactor is in the carbonator configuration. The exemplary system includes one or more valve mechanisms for alternately configuring each of the first and second reactors in the carbonator configuration and the calciner configuration.

In operation, the first reactor is configured in the carbonator configuration and the second reactor is configured in the calciner configuration by the valve mechanisms. During one time period, the first reactor, configured in the carbonator configuration, operates as a carbonator in which carbonation takes place. The second reactor, configured in the calciner configuration, operates as a calciner in which the calcination takes place. When the sorbent in the fixed sorbent bed of the carbonator approaches a saturation level, changeover takes place in which the first reactor is configured in the calciner configuration and the second reactor is configured in the carbonator configuration by the valve mechanisms. During a subsequent time period, the first reactor, configured in the calciner configuration, operates as a calciner in which calcination takes place. The second reactor, configured in the carbonator configuration, operates as a carbonator in which carbonation takes place. In an exemplary embodiment, the valve mechanisms may periodically configure the first and second reactors to alternate between the carbonator and calciner configurations, such that the first reactor is in the carbonator configuration when the second reactor is in the calciner configuration and the first reactor is in the calciner configuration when the second reactor is in the carbonator configuration.

In an exemplary embodiment, the fixed bed contains both the sorbent and a catalyst used to promote steam reforming of methane in the syngas.

In an exemplary embodiment, the one or more valve mechanisms include one or more shutoff valves and one or more flow control valves.

In an exemplary embodiment, the one or more valve mechanisms configure the fixed-bed reactor from the carbonator configuration to the calciner configuration when the sorbent in the fixed bed approaches or reaches a saturation level.

In an exemplary embodiment, the one or more valve mechanisms include one or more shutoff valves and one or more flow control valves.

In exemplary embodiments, the bed material of the reactor includes a composite structure comprised of a coating and a substrate. The coating includes the sorbent, and the substrate is chemically inert with regard to carbon dioxide or has reduced reactivity with regard to carbon dioxide. The ratio of the coating to the substrate is used to limit the temperature swing of the fixed-bed reactor as it is cycled between the carbonator configuration and the calciner configuration. The bed material may also include a catalyst used for steam reforming of methane. The composite structure may include the catalyst.

In an exemplary embodiment, the sorbent is provided in a composite structure, whereby the chemically-active sorbent outer layer coats an inner substrate which is chemically inert with regard to carbon dioxide or which has a reduced reactivity with regard to carbon dioxide. The composite structure may be in the form of pellets or rigidly-mounted rods. In operation, the outer sorbent coating adsorbs the carbon in a syngas during carbonation and desorbs the carbon during calcination. The inner substrate absorbs heat generated during carbonation and release the heat to provide a heat required for calcination to take place. The sorbent coating may be attached onto the substrate using a brazing alloy.

In an exemplary embodiment, the sorbent coating in the sorbent pellets includes a mixture of calcium oxide and calcium aluminate. In an exemplary embodiment, the substrate in the sorbent pellets includes calcium aluminate. In an exemplary embodiment, the sorbent coating includes calcium oxide and the substrate includes calcium oxide sorbent. In an exemplary embodiment, the sorbent coating includes calcium oxide and the substrate includes a dense cement, where the cement may be calcium aluminate in an exemplary embodiment. In an exemplary embodiment, the substrate may include the same material as the sorbent coating, but the substrate may be rendered chemically inert with regard to carbon dioxide.

In an exemplary embodiment, the composite sorbent structures (e.g., the pellets or rods) are supported in the fixed sorbent bed by one or more mechanical structures to minimize the weight of the fixed sorbent bed bearing down on the composite structures. The mechanical structures may include tower packings disposed in the fixed sorbent bed and/or one or more distributors configured to minimize the height of the bed.

In an exemplary embodiment, a first fixed-bed reactor is provided including a first fixed sorbent bed, the first reactor alternately configured in the carbonator configuration and the calciner configuration. A second fixed-bed reactor is provided including a second fixed sorbent bed, the second reactor alternately configured in the calciner configuration and the carbonator configuration. The first reactor is configured in the carbonator configuration when the second reactor is configured in the calciner configuration, and the first reactor is configured in the calciner configuration when the second reactor is configured in the carbonator configuration. One or more valve mechanisms may configure the first and second reactors substantially simultaneously.

In accordance with yet another exemplary embodiment, a method is provided of realizing a reduction in carbon dioxide emissions from an existing power plant by upgrading or retrofitting the existing power plant to include an exemplary adiabatic calcium looping carbon capture system. An existing power plant may be upgraded or retrofitted to include a hybrid integrated gasification combined cycle (IGCC) plant that implements low-cost carbon capture. An existing power plant may be repowered to increase the generating capacity of the power plant. The fossil fuel may be coal.

### BRIEF DESCRIPTION OF THE DRAWINGS

FIG. 1 illustrates an exemplary ACL system which implements sorbent-enhanced reaction (SER) using fixed-bed reactors.

FIG. 2 is a block diagram of an exemplary ACL used to remove carbon dioxide from an integrated gasification combined cycle (IGCC) plant.

FIG. 3 is an exemplary block diagram of the syngas warm-gas cleanup system (WGCU) that prepares the syngas for SE-SMR.

FIG. 4 is an exemplary block diagram that illustrates the changeover system for an exemplary ACL system.

FIG. 5 illustrates the reaction zone in the bed of an ACL reactor, in which the composition of the sorbent varies.

FIG. 6 is a graph that describes the relationship between the percentage of the thermal capacity of the sorbent that is chemically active, and the temperature difference between the calciner and the carbonator.

FIG. 7 is a graph that illustrates the partial pressures of carbon dioxide in exemplary calcium-based sorbents, and the temperatures and pressures of carbonation and calcination of an exemplary ACL system.

FIG. 8 is a graph that illustrates exemplary operating temperatures in the different reactors in conventional carbon capture systems, and exemplary operating temperatures in the different reactors in exemplary ACL systems.

FIG. 9 is a graph that illustrates the effect of combining SER with steam methane reforming on the efficiency of converting methane into carbon dioxide.

FIG. 10 illustrates the structure of the sorbent used in the exemplary ACL system.

FIG. 11 illustrates an interior perspective of an ACL reactor containing rectangular sorbent rods.

FIG. 12 illustrates an interior longitudinal view of an ACL reactor containing sorbent rods.

FIG. 13 illustrates an interior isometric view of rectangular sorbent rods within an exemplary ACL reactor.

FIG. 14 illustrates an interior isometric view of round sorbent rods within an exemplary ACL reactor.

FIGS. 15A and 15B illustrate views of an exemplary distributor plate used in ACL reactors.

FIG. 16 is a simplified schematic of an exemplary moving-bed ACL system.

### DETAILED DESCRIPTION

Carbon capture and sequestration (CCS) systems reduce the carbon content in syngas and sequester the carbon content removed from the syngas. Fitting a power plant with a carbon capture system to reduce its carbon dioxide emissions is an effective tool against global warming. Capturing the carbon dioxide from new and existing coal plants has emerged as one of the major challenges for modern society faced with global warming. A key difficulty is that the installation of carbon dioxide scrubbers needed for carbon-capture-and-sequestration (CCS), are added to existing coal plants—“add-ons”, by the current vernacular—benefits the environment, but creates a substantial financial loss for the companies paying for them. As such, fitting a power plant with a conventional carbon capture system typically incurs a financial loss, rather than a profit, for the power plant owner. This financial loss disincentivizes the application of conventional carbon capture systems to retrofit power plants. Therefore, the use of CCS to date has been limited to experimental facilities only.

A market for CCS can be established if the carbon capture system is incorporated in a system that provides new generating capacity by repowering existing coal fired power plants, if its cost of electricity, even with carbon capture, is competitive with alternative sources of new power, such as pulverized coal plants without CCS. At least in countries where coal is the fuel of choice by utilities, but environmental pressures keep such plants from being permitted unless they include carbon capture, this approach provides a way to provide carbon capture even in the absence of carbon taxes or subsidies.

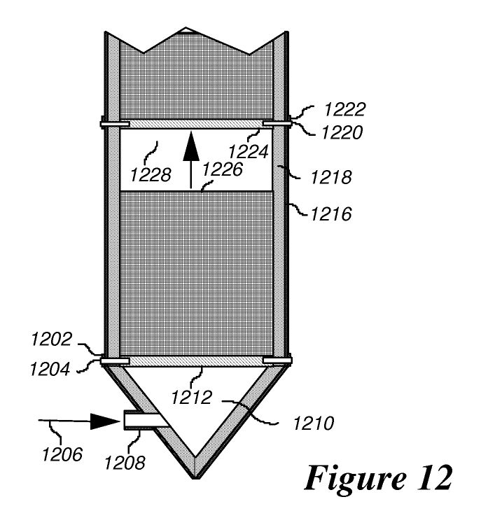

To achieve the cost target, both the power plant and the carbon capture system are both efficient and inexpensive. In some embodiments, the power plant is a mild-gasification airblown IGCC, exemplary embodiments of which are described in International (PCT) Patent Application Serial Number PCT/US2009/069455, filed Dec. 23, 2009, entitled “Mild Gasification Combined-Cycle Powerplant,” e.g., at FIG. 12 and accompanying description, the entirety of which is incorporated herein by this reference.

In addition to also being efficient and inexpensive, the carbon capture system accommodates two technical issues specific to airblown IGCCs: the presence of significant amounts of methane in the syngas, and significant amounts of nitrogen in the syngas.

The methane in the syngas of airblown gasifiers reduces the carbon capture efficiency below the 90% that is an exemplary target of carbon capture systems, unless the methane is first converted into another gas (carbon monoxide) which can then be converted into carbon dioxide and captured. The nitrogen increases the energy requirements for regenerating the sorbent, when conventional carbon capture systems using physical solvents are used.

While both methane and nitrogen can be accommodated by conventional systems, their added cost currently makes them unaffordable. The systems, methods and equipment provided herein can be employed to address some and, in some cases, all of the above simultaneously.

Exemplary embodiments provide carbon capture systems that pay for their application in power plants and, thereby, cure the deficiencies in conventional carbon capture systems. For example, exemplary embodiments provide at least the following advantages:

High carbon capture efficiency. Exemplary carbon capture systems achieve sufficiently high carbon capture efficiency, typically about 90%, which meets regulatory requirements.

Inexpensive system. Exemplary embodiments provide new and retrofitted or upgraded existing power plants with exemplary carbon capture systems whose resulting cost of electricity generation, including carbon capture, is sufficiently low to be competitive with the power generated by conventional power plants that do not implement carbon capture.

To meet these requirements, the power generating equipment used in exemplary embodiments is considerably less costly than conventional power plants to leave sufficient money left over to pay for the exemplary carbon capture system. Suitable technology for providing low-cost power is an airblown integrated gasification combined cycle (IGCC) plant such as that described in exemplary embodiments of which are described in International (PCT) Patent Application Serial Number PCT/US2009/069455, filed Dec. 23, 2009, entitled “Mild Gasification Combined-Cycle Powerplant,” e.g., at FIG. 12 and accompanying description, the entirety of which is incorporated herein by this reference. Exemplary carbon capture systems are technically compatible with IGCCs.

New generating capacity. Exemplary carbon capture systems may be applied in power plants when new generating capacity is required, whether in repowering applications or for new facilities. The repowering may be of Rankine Cycle plants or combined cycle plants. Applying exemplary embodiments when new generating capacity is needed provides capital that might not be available if the only purpose of an investment were to provide carbon capture.

### A. Simplified Description of ACL

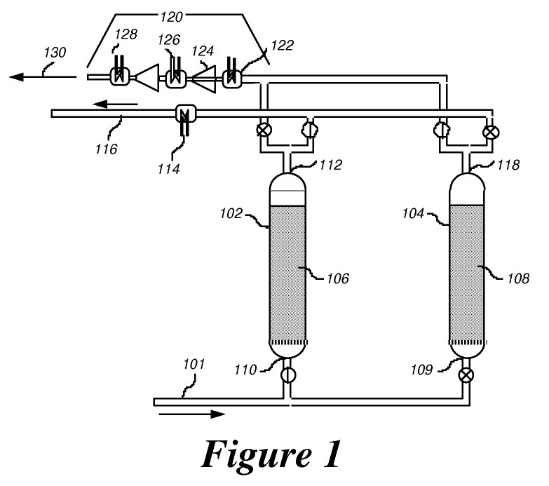

Simplified flow diagram. FIG. 1 illustrates an exemplary ACL system which implements sorbent-enhanced reaction (SER) using fixed-bed reactors. A fixed-bed reactor is one in which the materials in its bed remain stationary. The exemplary ACL system of FIG. 1 includes fixed-bed reactors 102 and 104, each of which is configurable to operate as either a carbonator and as a calciner. The ACL system includes one or more valves that configure reactor 102 to be alternately configured as a carbonator and a calciner and that configure reactor 104 to be alternately configured as a calciner and a carbonator, such that reactor 102 is configured as a carbonator when reactor 104 is configured as a calciner, and vice versa.

When the valves in FIG. 1 are in the positions shown, reactor 102 is the carbonator and reactor 104 is the calciner. When each of the valve positions is reversed, reactor 102 is a calciner and reactor 104 is a carbonator.

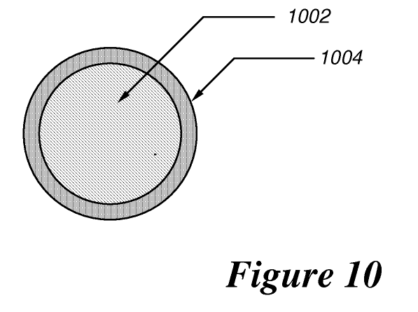

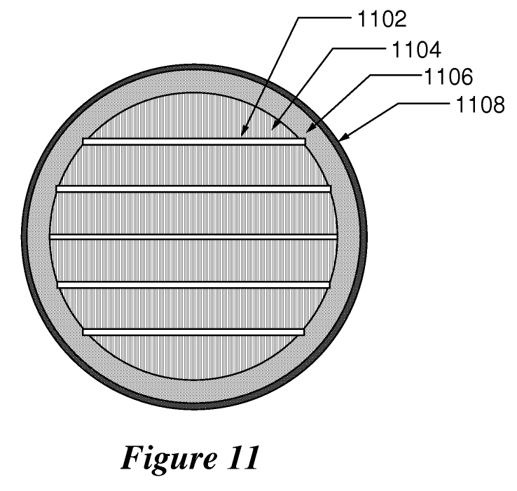

Reactors 102 and 104 include fixed sorbent beds 106 and 108, respectively, each of which holds a mixture of the calcium-based sorbent and catalysts. The beds 106 and 108 may include sorbent pellets such as those illustrated in FIG. 10, or assemblies of rods such as those shown in FIGS. 11, 13 and 14. Each reactor contains a bed of sorbent in addition to, in an exemplary embodiment, catalyst for steam reforming methane. In an exemplary embodiment, the catalyst is porous nickel.

Reactor 102 includes an inlet 110 connected to an inlet pipe 101 through which syngas and steam can enter reactor 102 for carbonation. Reactor 102 includes an outlet 112 through which gases can leave reactor 102. During carbonation, syngas containing steam enters reactor 102 through inlet 110, is decarbonized through the sorbent bed 106, and are emitted through outlet 112.

Similarly, reactor 104 includes an inlet 109 connected to the inlet pipe 101 through which syngas containing steam can enter reactor 104 for carbonation. Reactor 104 includes an outlet 118 through which gases can leave reactor 104. During carbonation, syngas containing steam enters reactor 104 through inlet 109, is decarbonized through the sorbent bed 108, and are emitted through outlet 118.

From the reactors 102 and 104, the syngas released by carbonation is piped to cooler 114 and conduit 116 which is connected to a gas turbine in the case of an IGCC, or a synthesizer in the case of a chemical plant. Cooler 114 is provided to meet the temperature limits of the gas turbine's control valve.

The ACL system includes a compressor assembly 120 that compresses CO₂ generated during calcination to a pipeline pressure. The compressor assembly 120 pulls a vacuum at the outlet (outlet 112 when reactor 102 is operating as the calciner, and outlet 118 when reactor 104 is operating as the calciner) of the calciner so that the calciner operates under the vacuum. The vacuum is provided to regenerate the sorbent during calcination in the calciner. The compressor assembly 120 includes a cooler 122 for cooling the released CO₂, which enables the compressor to operate a high efficiency. The compressor assembly 120 also includes a succession of intercoolers 126 and compressors 124, 128. A final cooler may be included to condition the CO₂ to pipelines requirements of a pipeline 130 before it enters pipeline 130 on its way to the sequestration site

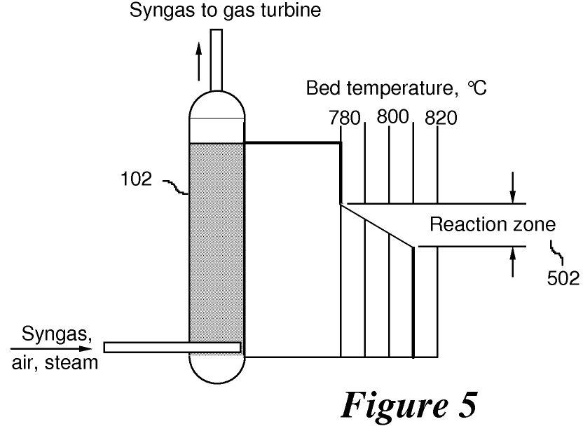

Simplified operation. At the start of each cycle, immediately after the valve positions have been changed, the sorbent in the carbonator is fresh, and the incoming syngas is converted in a reaction zone at the bottom of the reactor. As time progresses and sorbent becomes consumed, the reaction zone 502 moves upwards in the reactor, as shown in FIG. 5. To avoid the top of the reaction zone from reaching the top of the bed or, in other words, having the CO₂ “breaking through,” the valves of FIG. 1 are reversed to configure what had been the carbonator into a calciner and what had been a calciner into a carbonator before the top of the reaction zone reaches outlet 112. For example, if the reactor 102 was previously configured as the carbonator and the reactor 104 was previously configured as the calciner, then the reversal of the valves configures the reactor 102 into the calciner and configures the reactor 104 into the carbonator. This cycle may then be repeated any number of times or indefinitely.

The ACL system of FIG. 1 maintains a constant supply of syngas by using two reactors, at least one of which is outputting syngas in carbonation.

An exemplary ACL system may include a single reactor which is alternately configured as a carbonator and a calciner. Other exemplary ACL systems may include any number of reactors.

### B. Structures

Reactor cross-section. The cross-section of reactor 102 or 104 is shown in FIG. 12. It includes an inlet 1208 for syngas and steam 1206 that enters plenum 1210 beneath distributor plate 1212. Gases passing through the distributor plate pass through bed 1226 before entering plenum 1228 and to a second bed over distributor 1224. There may be as few as one bed, or as many as several. The distributor plates are held in place by lugs 1204 and 1220, respectively, that are mounted in reinforcing rings 1202 and 1222. The reactor is insulated by refractory 1218, which is mounted on pressure-vessel casing 1216.

Beds made of pellets. In an exemplary embodiment, beds 106 and 108 are comprised of pellets. The multiplicity of beds in FIG. 12 is typical of beds comprised of pellets, where the weight of the bed would crush pellets in the lower regions of the bed unless the bed heights themselves were limited, as shown in FIG. 12. Alternatively, tower packings may be mixed with the sorbent pellets, which relieve the forces on the pellets by instead transmitting the forces from the weight of the bed through the packings instead of the pellets, which may be built more strongly than the sorbent. In that case, fewer, or no, upper beds may be required.

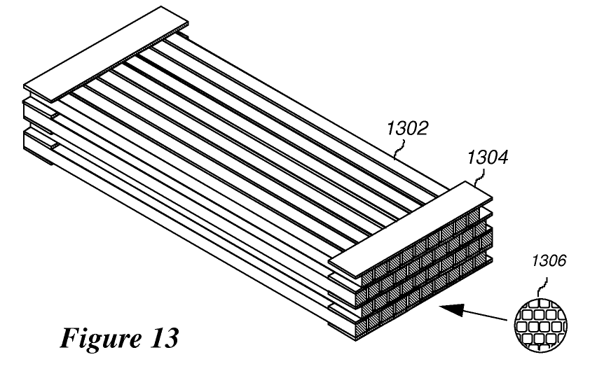

Beds made of rods. In an exemplary embodiment, the sorbent may be made of rods rather than pellets. FIG. 13 shows an assembly of rectangular rods 1302 held apart by spacers 1304. FIG. 11 is an interior plan view of a reactor, showing spacers 1102 going across the entire diameter of the reactor. Rods 1104 may also cross the entire cross-section of the reactor. The reactor includes refractory lining 1106 mounted inside pressure vessel casing 1108.

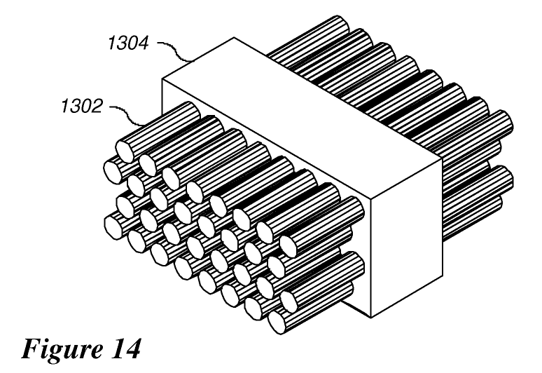

The rectangular rods are offset from one another, as shown in 1306 of FIG. 13, to use a maximum amount of surface for heat transfer around each rod. Alternatively, the rods 1302 may be round, as shown in FIG. 14. The rods are mounted in tubesheets 1304 that are load-bearing elements mounted on the distributor plate. This construction eliminates the forces caused by the weight of the bed from being transmitted to the rods. Tube sheets, or other structures that avoid transmitting the force caused by the weight of the bed, may also be advantageous with rectangular rods, in case the forces transmitted through the spacers exceed their strength limits.

In various embodiment, the rods may be sorbent, catalyst, or mixtures of sorbent and catalyst. Generally, while other shapes can be employed, round rods provide for the most uniform heat exchange, but require larger reactors than rectangular rods.

Stationary sorbent. One challenge with ACL systems is the large difference in gas densities between the carbonator and the calciner. In order to avoid particle attrition, fixed bed reactors can be employed to avoid fluidization of the bed material. To avoid fluidization, the large differences in gas densities lead to the use of very large sorbent particles or to the use of calciners with very large diameters. Large sorbent particles tend to have slow reaction times that lead to large vessel sizes, while large calciners tend to be costly and inefficient. One of the improvements provided by exemplary embodiments is to cure these deficiencies of conventional systems by providing composite sorbent pellets that have a dense substrate coated by a layer of the sorbent material or by providing sorbent that take the form of rods that may be rigidly mounted.

Rod, in some instances, may be costlier to manufacture, and may be more subject to breakage. On the other hand, they have the following advantages over pellets:

a. Reduced stress from the bed weight. A key advantage of rods is that the weight of the bed is sustained by the support structures rather than by the sorbent itself, as is true in beds made of pellets. While the stresses on pellets can also be reduced, by the use of column packings, or multiple distributors, each of these would increase the size and cost of the reactors.

b. Bed replacement. The sorbent rods can readily be separated from the catalyst rods, if one of these must be replaced but not the other. With pellets, special classifiers would be required to separate the sorbent from the catalyst.

c. Minimum fluidization velocities. Because they are rigidly held in place, rods do not have a gas velocity limitation that might limit the diameters and operation of the reactors with pellets, both during normal operations and during changeovers.

d. Exposed surfaces. More of the rod surface is exposed to syngas than that of pellets, whose regions in the vicinity of their points of contact are relatively inaccessible to the flow of gases. This further reduces the size and cost of the reactors using rods.

e. Flow uniformity. Flows in fixed beds are subject to channeling due to variations in the blockage of the bed materials. This problem may be reduced or eliminated by the geometric precision of the rods, including the use of spacers to keep them accurately positioned, if necessary.

Distributor plates. In an exemplary embodiment, a distributor plate is placed at the bottom of each reactor, as illustrated in FIG. 12. In some embodiments, the distributor plate has at least the following functions: (i) the plate supports the column of sorbent in the bed of the reactor, (ii) it uniformly distributes the flow of gases entering the carbonator's bed across its cross-section; and (iii) it transmits the weight of the sorbent assemblies through cooled lugs 1206 and 1220 to reinforcing rings 1202 and 1222 at the outside of the reactor vessel 1208, as seen in FIG. 12.

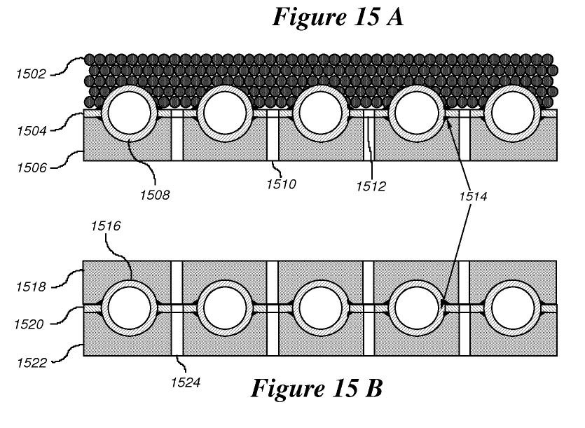

In exemplary embodiments employing sorbent pellets, the velocity of syngas entering the bottom of the bed is limited below that which would cause the pellets to be fluidized. For this, the construction of, e.g., FIG. 15A or FIG. 15B can be employed. The structural strength of the distributor plate comes from its fin-tube assembly whose coolant enables it to withstand the forces created by the weight of the sorbent. Fin-tube assemblies are welded structures comprised of a series of flat strips of steel 1504 welded by welds 1514 to a series of cooled tubes 1508 through which flow coolant such as steam. To minimize heat losses, the fin-tube assembly is insulated underneath by refractory 1506, such as a castable insulating refractory, which incorporates a series of holes 1510 that are aligned with holes 1512 in the fin-tube assembly. In both FIGS. 15A and 15B, the holes enable the gases to flow through the distributor plate. These holes are restrictive enough to provide uniform gas flow across the plate, but not so restrictive as to cause excessive pressure drops that would significantly increase compressor power requirements.

The top surface of the fin-tube is also insulated in an exemplary embodiment. If the sorbent bed is made of rods, the insulating refractory 1518 can be the same as refractory 1522, as seen in FIG. 15B. If the sorbent bed contains pellets, an exemplary embodiment is shown in FIG. 15A, whereby the top surface of the fin tube assembly is covered by a porous plate that diffuses the high-velocity jet emerging from port 1512 into a uniform low-velocity flow emerging from the top of assembly 1502 into the bed of pellets. This prevents the pellets from being entrained by high-velocity jets that would cause attrition. In the exemplary case of FIG. 15A, top layer 1502 consists of an assembly of refractory spheres that has been cemented or fused to form a monolithic structure.

### C. Chemistry of ACL

In some embodiments, the ACL employs sorbent-enhanced reaction (SER). In the SER described herein, two reactions occur simultaneously in the same reactor vessel. Equation (1) describes the water-gas shift reaction, by which steam added to the syngas produces CO₂ and hydrogen:

CO+H₂O->CO₂+H₂−17,700 BTU/lb-mol of CO (exothermic) (1)

The second reaction is the absorption of the CO₂ by the CaO in the sorbent to form calcium carbonate:

CO₂+CaO->CaCO₃−76,930 BTU/lb-mol of CO₂ (exothermic) (2)

During calcination, the reaction of equation 2 is reversed:

CaCO₃->CaO+CO₂+76,930 BTU/lb-mol of CO₂ (endothermic) (3)

Methane is converted into hydrogen and carbon monoxide by steam methane reforming:

CH₄+H₂O->CO+3H₂+88,932 BTU/lb-mol of CH4 (endothermic) (4)

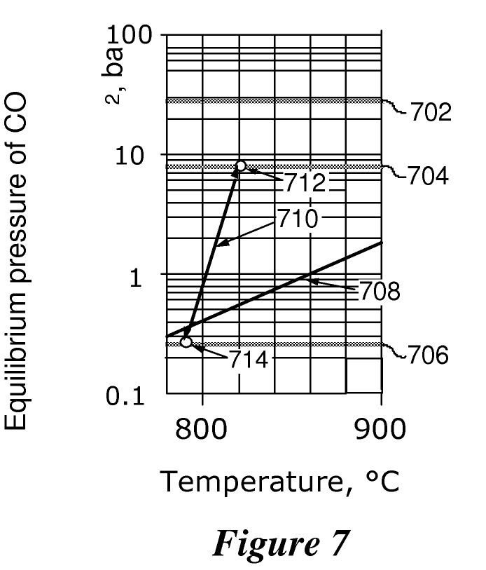

Operating temperatures and pressures. FIG. 7 is a graph that illustrates the partial pressures 708 of carbon dioxide in exemplary calcium-based sorbents and the temperatures and pressures of carbonation 712 and calcination 714 of an exemplary ACL system. The conditions of ACL are shown in FIG. 7. Calcium looping occurs only when the conditions in the carbonator 712 are on one side of line 708, and the conditions in the calciner 714 are on the other side. Line 710 represents the vapor within calcium-based sorbent, and line 708 represents the path that the sorbent experiences during calcium looping. The vapor pressure 704 of CO₂ in the syngas is directly proportional to the total pressure 702 in the syngas entering the carbonator. The ratio of these pressures depends on the other constituents in the syngas. In an IGCC application, the total pressure 702 is determined by the pressure in the carbonator.

ACL is a pressure-swing process, whereby the pressure 706 in the calciner has to be below that of line 708 at the calciner temperature, otherwise, regeneration does not occur. Pressure 706 is sub-atmospheric. A vacuum to create the sub-atmospheric pressure 706 is provided by the compressor assembly 120 of FIG. 1.

In some embodiments, the conditions of FIG. 7 are carefully selected to optimize system performance. At lower temperatures, the vacuum required in the calciner is even more severe, increasing the compressor power requirements. At higher temperatures, the carbon collection efficiency is reduced, or the steam consumption rises.

The temperature of the carbonator is determined by the temperature of the incoming gases, while the temperature swing, of about 30° C. in FIG. 7, is determined by how much of the sorbent is in close thermal contact with a heat sink. The temperature swing is the difference between the sorbent temperature in the calciner versus the carbonator.

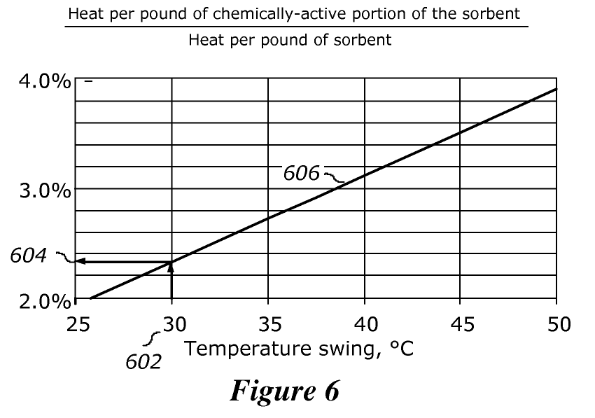

Without a heat sink, a particle of sorbent would heat up by nearly about 1200° C. when going from fully calcined to fully carbonated. How much of the sorbent, e.g., particle or rod, can be chemically-active, for a given temperature swing, is shown on curve 606 on FIG. 6. For the 30° C. temperature swing indicated on FIG. 7, the thermal content of the chemically-active part of the sorbent is only, e.g., 2.36% of the particle's total thermal mass (item 604, on FIG. 6). The small ratio means that more sorbent may be needed than with larger temperature swings, but that the sorbent coating is correspondingly thin, which creates fast reaction times.

Reaction time. How long it takes for the sorbent to become fully reacted depends on its porosity and the thickness of the sorbent layer. For example, a small particle of sorbent, only about 100μ particle in diameter, can reach its equilibrium level of carbonation in only a second after being immersed in a stream of CO₂. The more quickly the particle reacts, the shorter the reaction zone 502 (FIG. 5) is, and the more of the sorbent in the reactor can be utilized on during the cycle.

Accordingly, in some embodiments, the sorbent diameter is small enough to achieve fast reaction times. Additionally, in some embodiments, additives are included in the sorbent, e.g., added during manufacture, to maintain the patency of its pores. The additive enables the sorbent to stabilize at a relatively high reactivity, and it enables the sorbent to reach this equilibrium reactivity after only a few cycles, after which the reactivity remains constant.

The time required for calcination to be completed is somewhat shorter than for carbonation, which might enable the use of an unsymmetrical number of reactors. For example, there may at any one time be only one calciner in operation while there are two carbonators. The rate at which the sorbent calcines is determined primarily by the pressure in the calciner, which in turn is determined by the vacuum drawn on it by the compressor assembly 120 in FIG. 1. The rate is kept relatively constant during the cycle, to even out the flow to the compressor assembly and thereby maintain its operating stability.

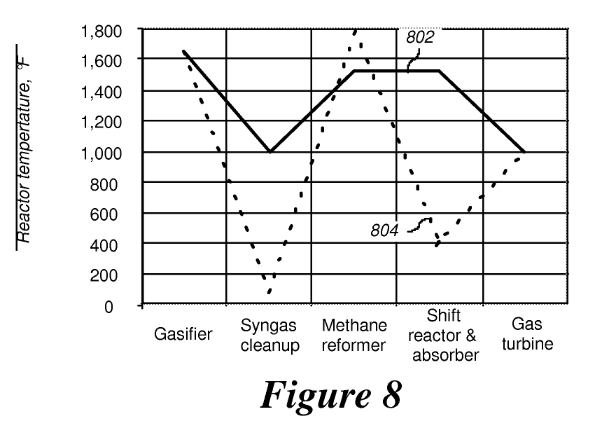

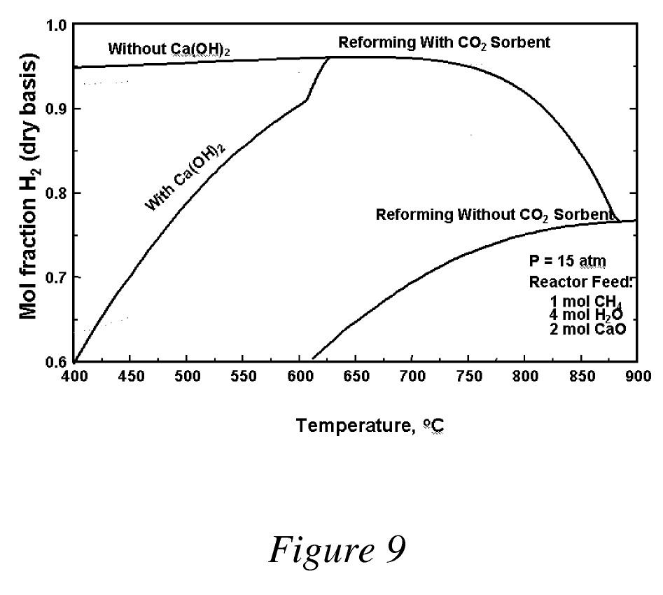

Steam methane reforming. Exemplary embodiments combine steam methane reforming (SMR) with sorbent-enhanced reaction (SER) in the same reactor vessel in a process known as sorbent-enhanced steam methane reaction (SE-SMR). SE-SMR significantly increases the conversion efficiency, to about 90% at the approximately 820° C. carbonator temperature from FIG. 9, versus the approximately 76% conversion efficiency in a free-standing reactor that reforms steam independently of SER. This means that, when both reactions were carried out at approximately 820° C., the CO₂ emitted per hour due to methane would be about 2.4 times as high if SMR were carried out independently of SER, than if they were combined in a single vessel. In fact, an independent SMR reactor would probably be operated at a higher temperature, to increase the CH₄ conversion efficiency, as seen in peak temperature of line 804 in FIG. 8 (“Methane reformer”). However, operating at the higher temperature both increases the equipment cost and reduces plant efficiency.

SMR requires the use of a catalyst. In an exemplary embodiment, the catalyst is porous and made of nickel. In an exemplary embodiment, the top portion of each sorbent bed is devoid of catalyst, to minimize the emission of carbon dioxide from the carbonator. Eliminating catalyst from the top of the bed causes the steam reforming of CH₄ to occur in the lower portions of the bed, which allows it to be converted into CO₂ which is then removed from the syngas before the syngas leaves the reactor.

Cycle time and reactor size. The shorter the cycle time, the smaller and less costly the reactors. With the changeover procedure that does not penalize the system for short residence times, a time as short as about 2 minutes has been assumed. Exemplary reactors may have beds with bed dimensions only about 12.5 ft ID×about 40 ft high. A spare reactor is provided in an exemplary embodiment for maintenance.

### D. Composite Sorbent

An exemplary solution to controlling the temperature swing is the use a composite sorbent in which a layer of sorbent 1004 coats a dense substrate 1002 that forms the core of the structure, as illustrated in FIG. 10. The composite sorbent structure may take the form of sorbent pellets or sorbent rods. In an exemplary embodiment, the sorbent pellet coating is made from a slurry containing CaO and calcium aluminate cement. In an exemplary embodiment, the formulation for the sorbent coating is about 10% cement and about 90% sorbent.

Use of a composite controls the temperature swing, as the particle cannot continue to heat up after the surface is fully reacted. Without it, the temperature swings in the carbonators would be uncontrolled, resulting in a wide range of temperatures in the reactor beds which would make fixed-bed ACL unfeasible.

In an exemplary embodiment, a small amount of cement is added to the sorbent coating, such as calcium aluminate cement. Its function is to substantially increase the reactivity over that of pure sorbent, thereby thinning the surface layer and speeding up the reaction time. The other function is to stabilize the reactivity.

In an exemplary embodiment, the substrate that forms the core of the sorbent pellet is made entirely of calcium aluminate cement. Calcium aluminate cement is a suitable constituent of the substrate for several reasons. Calcium aluminate is a strong cement, which enables it to withstand the structural forces in the bed and also form a strong bond with the coating. Calcium aluminate is over three times as dense and has a specific heat about a third greater than calcium oxide. Together, these properties of calcium aluminate allow reduction in the size and cost of the reactors by nearly three quarters.

In another exemplary embodiment of the core, some sorbent is mixed with the calcium aluminate substrate, although a smaller percentage than in the coating. The sorbent in the substrate reacts more slowly than that of the coating, because it is further from the surface, and because its concentration is lower. The function of the sorbent in the substrate is to compensate for reductions in the reactivity of the surface that might occur over time, by providing additional sorbent capacity, even if it reacts more slowly than the surface material. The effect of a slower reaction time is to lengthen the reaction zone of FIG. 5, which reduces the overall capacity of the reactor and with it, reduces the cycle time.

In an exemplary embodiment, the coating of the composite structure is attached to the core substrate by a cement, which may include the cement in the coating as well as in the core.

In an exemplary embodiment, the coating and substrate are manufactured simultaneously, by hydrating the mixtures and forming them into the desired shape. Alternatively, another adhesive may be used to attach the coating to the core substrate including, but not limited to, brazing alloys.

Yet another exemplary embodiment uses a single material for the entire sorbent pellet or sorbent rod, in order to eliminate the possibility of the surface layer delaminating from the core. However, the interior of the particles or rods is rendered inert, by, for example, sintering or sulfating, before the surface layer is added.

Reactivation. The data on cycling of calcium-aluminate-treated sorbent goes to only about 2000 cycles, during which the sorbent's reactivity is totally stable. If the calcium looping cycle occurs about every 2 minutes, the 2000 cycles may occur about every 2.7 days. While there is no reason to believe the reactivity will change over time, if it does, the sorbent may be reactivated by hydration. In an exemplary reactivation process, the reactor is taken out of service and cooled to near-ambient temperatures, and then exposed to an atmosphere of water vapor. Hydration requires that the sorbent be exposed to moisture for half a day before the reactor is returned to service. Reactivation by hydration may be repeated as often as necessary.

### E. Changeover

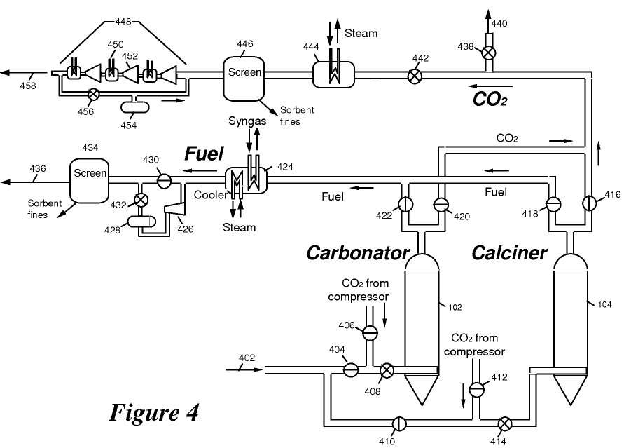

“Changeover” describes the alternate configuration of the reactors in order to switch their functions. FIG. 1 shows a simplified version of how the functions of the reactors are reversed when each of the valves is switched. FIG. 4 is an exemplary block diagram that illustrates the changeover system for an exemplary ACL system.

During changeover, the top of each reactor contains a mixture of the two gases. Since this mixture is suitable for neither purpose (combustion or sequestration), a method is developed for dealing with this problem. For example, CO₂ in the gas mixture, if it were fed to the gas turbine, could interfere with combustion. Alternatively, the syngas in the flow to the CO₂ compressor could exceed the purity standards for sequestration. Further, the loss of energy in the syngas of the gas mixture is not allowed to be significant.

To avoid these problems, the valving of FIG. 4 is used to replace the valving of FIG. 1 in exemplary embodiments. In an exemplary embodiment, these problems are minimized by first having each reactor be decompressed to the low pressure of the calciner before the reactors are purged. This reduces the amount of material in each reactor during changeover to a small amount, on the order of about 0.1% of the system's throughput in exemplary embodiments. Furthermore, only a portion of the gases in the decompressed reactors contains the gas mixture. Thus, the overall amount of mixed gas that must be dealt with is only about 0.02% of the system throughput. Such small amounts can be readily mixed with the CO₂ stream being sequestered in exemplary embodiments.

Decompressing both reactors before they are purged and filled with the other gas, is an important feature of exemplary embodiments, as it enables the system to operate with short cycle times without the loss of significant amounts of either gas. Short cycle times are provided to minimize the size and cost of the reactors. With the changeover procedure that does not penalize the system for short residence times, a time as short as about 2 minutes has been assumed. Exemplary reactors may have beds with bed dimensions only about 12.5 ft ID×about 40 ft high. A spare reactor is provided in an exemplary embodiment for maintenance.

In FIG. 4, reactor 102 is connected to an inlet pipe 402 through which syngas and steam can enter reactor 102 for carbonation. The flow of the syngas into reactor 102 is controlled by valve 404. The reactor 102 is also connected to an inlet pipe through which carbon dioxide can enter reactor 102, e.g., from a compressor (denoted as “CO₂ from compressor” in FIG. 4). The flow of the carbon dioxide into reactor 102 is controlled by valve 406. The flow of either the syngas and steam or the carbon dioxide into reactor 102 is further controlled by valve 408 which is positioned downstream from valves 404 and 406.

Similarly, reactor 104 is connected to the inlet pipe 402, or to a different inlet pipe, through which syngas and steam can enter reactor 104 for carbonation. The flow of the syngas into reactor 104 is controlled by valve 410. The reactor 104 is also connected to an inlet pipe through which carbon dioxide can enter reactor 104, e.g., from a compressor (denoted as “CO₂ from compressor” in FIG. 4). The flow of the carbon dioxide into reactor 104 is controlled by valve 412. The flow of either the syngas and steam or the carbon dioxide into reactor 104 is further controlled by valve 414 which is positioned downstream from valves 410 and 412.

Both reactor 102 and reactor 104 are connected to a syngas post-processing module. The syngas post-processing module includes a syngas cooler 424 that cools the syngas released from the reactors 102 and 104 during carbonation, a compressor 426 that compresses the cooled syngas, an accumulator 428 that accumulates the syngas, and a strainer/screen 434 that filters sorbent fines. The processed syngas is then released through outlet pipe 436 to, e.g., a syngas storage, a gas turbine, etc. Valve 422 controls the flow of the syngas from reactor 102 to the syngas post-processing module. Valve 418 controls the flow of the syngas from reactor 104 to the syngas post-processing module.

Both reactor 102 and reactor 104 are connected to a carbon dioxide post-processing module. The carbon dioxide post-processing module includes a vent line 440 that allows the carbon dioxide from reactors 102 and 104 to be released to, e.g., the outside atmosphere, a storage, a processing module, etc. The carbon dioxide post-processing module also includes a carbon dioxide cooler that cools the carbon dioxide, a strainer/screen 446 that filters sorbent fines, a compressor assembly 448 that includes a compressor 452 for compressing the carbon dioxide and an intercooler 450. The processed carbon dioxide is then released through outlet pipe 458 to, e.g., the outside atmosphere, a storage, a processing module, etc. Valve 420 controls the flow of carbon dioxide from reactor 102 to the carbon dioxide post-processing module. Valve 416 controls the flow of carbon dioxide from reactor 104 to the carbon dioxide post-processing module. Valve 438 controls the flow of carbon dioxide from either reactor 102 or reactor 104 to vent line 440, and valve 442 is disposed downstream of valve 438 to control the flow of carbon dioxide from either reactor 102 or reactor 104 to cooler 444.

An exemplary changeover procedure is as follows. In this example, reactor 102 is initially configured as a carbonator and reactor 104 is initially configured as a calciner. The changeover configures reactor 102 as a calciner and configures reactor 104 as a carbonator. The procedures for reactor 102 are steps a through c, and for reactor 104, steps d and e

a. The changeover is started when valves 404 and 430 are closed and compressor 426 drains the syngas in reactor 102 until its pressure is similar, for example, to the pressure as the calciner normally operates (of about 2 psia). During this time, the syngas from reactor 102 is pumped into the accumulator 428. The lower the pressure, the less gas remain in the reactor before changeover, and the less loss of syngas occurs. On the other hand, the lower the pressure, the more power is required to evacuate the reactor.

b. Reactor 102 is then isolated from the gas turbine by closing valve 422. Reactor 102 is then filled with CO₂ in preparation for its becoming a calciner, by opening valve 406. Valve 408 controls the flow rate to minimize the cycle time while avoiding fluidization of the bed if it is comprised of pebbles, or from creating excess pressure drop, if the bed is comprised of rods.

c. Just before the CO₂ used to flush out the syngas reaches the top of reactor 102, valve 442 is momentarily closed and valve 438 is momentarily opened, until the syngas/CO₂ mixture from the top of reactor 102 is vented to line 440. Valves 438 and 442 are then returned to their earlier positions. The few pounds of fuel in line 440, may be burned by the addition of air, or by venting it to a boiler.

d. In one exemplary embodiment, the changeover of reactor 104 begins at the same time as the start of the changeover of reactor 102. Valve 410 is opened, and the flow rate to reactor 104 is controlled by control valve 414 at a setting that minimizes the time to flush out reactor 104.

e. Just after reactor 104 is filled with syngas, valve 438 is opened until the syngas in the syngas/CO₂ mixture is vented. Valves 416 and 438 are then shut off, and valves 418 and 414 are opened.

Resumed operation. After the completion of changeover, the flows are adjusted as follows in an exemplary embodiment.

f. In an exemplary embodiment, flow from the new calciner (reactor 102) is controlled by the adjustment of control valve 442. The flow rate is limited to avoid the previously-identified problems associated with excessive flow rates through the sorbent beds.

g. In an exemplary embodiment, the flow rate through the new carbonator (reactor 104) is determined by the flow from the upstream systems, and is not controlled.

Transient conditions. The flow of CO₂ to the inlet of compressor assembly 120 varies over the cycle, particularly during the changeovers. To avoid compressor surge, CO₂ is recycled through control valve 446. Flow fluctuations at the inlet of compressor assembly 120 are further reduced by the addition of accumulator 448.

In a similar fashion, the fluctuations in the flow of syngas to the gas turbine during changeover are minimized by the storage of pressurized syngas in accumulator 428, whose pressure is created by compressor 428. The compressor draws syngas during normal operations, and not just during step “a” of the changeover procedure (described above). During the transients created during changeover, the pressurized syngas is then released to the gas turbine through control valve 428.

The function of the compressor assembly in FIG. 4 is the same as in FIG. 1. The strainers 434 and 446 remove any sorbent that may have deteriorated due to thermal cycling.

In exemplary embodiments, an axial-flow compressor is used in the first stage or stages of compression, to accommodate the very high volumetric flow rates emitted from the calciner. The compressor design is an important feature of the exemplary ACL system, because the pressure in the calciner is as low as about ⅕^{th} of an atmosphere, while the pressure of the CO₂ at the pipeline can be as high as about 150 atmospheres. Both the power requirement and the cost of the compressor are therefore significant. Exemplary compressors may include an advanced cryogenic system that pumps the CO₂ as a supercritical fluid. While additional energy is required for refrigeration, the pumping energy is greatly reduced and efficiency is increased by the cryogenic compressor system.

### F. IGCC Applications

ACL in an integrated gasification combined cycle (IGCC). In accordance with yet another exemplary embodiment, a method is provided of realizing a reduction in carbon dioxide emissions from an existing fossil fuel power plant by upgrading or retrofitting the existing power plant to include an exemplary adiabatic calcium looping carbon capture system. An existing power plant may be upgraded or retrofitted to include a hybrid integrated gasification combined cycle (IGCC) plant that implements low-cost carbon capture. An existing power plant may be repowered to increase the generating capacity of the power plant. The existing power plant may operate on the Rankine Cycle. The existing power plant may be comprised of a topping cycle and a bottoming cycle. The fossil fuel may be solid. The fossil fuel may be coal. The exemplary method may convert the fossil fuels into chemicals. The adiabatic calcium looping system may include a carbonator that is airblown in the product of the system is electricity, and oxygen-blown in the product is a chemical. The system in either case may be operated below the temperature at which molten slag is formed. Exemplary systems may use mild gasification.

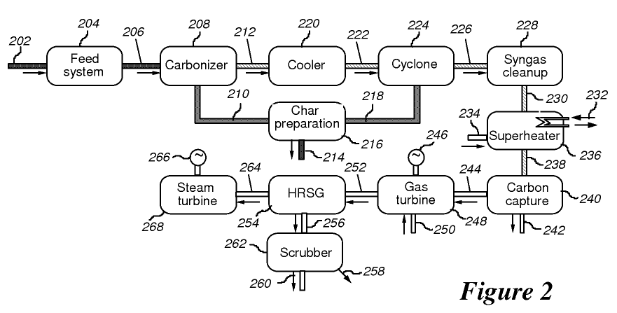

The application of an exemplary ACL system in an IGCC plant is shown in FIG. 2. The IGCC, which is described in greater detail in the referenced applications, includes fuel preparation system 204, carbonator 208, syngas cooler 220, cyclone 224, char preparation system 216, and syngas cleanup system 228, and superheat 236. In an exemplary embodiment, syngas cooler 220 is a spray quench vessel in which water is used to cool the syngas to the inlet temperature required by the syngas cleanup system. The water is later used to convert CH₄ and CO into CO₂. The exemplary carbon capture system includes the ACL system of FIGS. 1 and 4.

The IGCC also includes the combined cycle system that includes gas turbine-generator set 248 which generates electricity 246, a heat recovery steam generator (HRSG) 254, mercury scrubber 262, and steam turbine generator 268 that produces electricity 266.

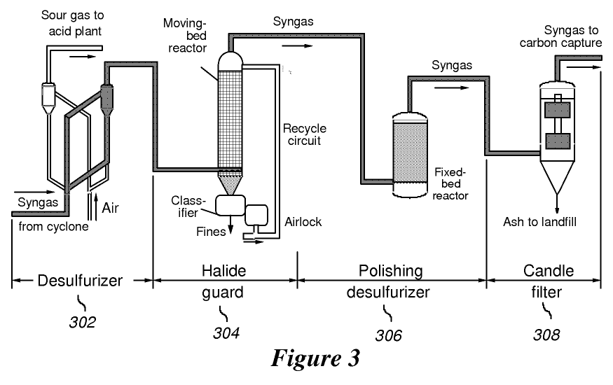

In an exemplary embodiment, syngas cleanup system 228 includes desulfurizer system 302, halide guard 304, polishing desulfurizer 306, and candle filter 308, illustrated in FIG. 3. The polishing desulfurizer is required to reduce the concentration of sulfur compounds, including hydrogen sulfide (H₂S), and carbonyl sulfide (COS), to the levels needed to avoid the deactivation of the nickel catalyst in beds 106 and 108.

The exemplary carbon capture system illustrated in FIG. 2 includes the superheater 236 and ACL 212. Superheater 236 raises the syngas temperature from that of the syngas cleanup system that, in the exemplary embodiment, is between about 850° F. and about 1000° F. The syngas temperature is increased to that required by the carbonator, as shown in FIG. 7. Some of the heat is provided by syngas being cooled in cooler 114. The remainder of the heat is provided by the partial combustion of syngas by the injection of air into a combustion section of superheater 236.

The heat for SMR is largely provided by the water-gas shift reaction. To the extent that these are not balanced, the temperature at the outlet of superheater 236 is adjusted accordingly.

An exemplary IGCC may include a carbonator, a system for burning char fines, a syngas cooler, a syngas warm-gas cleanup system, a system for reducing the carbon dioxide emissions from the system, and a system for drying and feeding solid fuel to the carbonator. In an exemplary embodiment, the syngas cooler is a bubbling fluidized bed with coolant tubes immersed therein in installations without carbon capture, and a water-spray cooler in installations with carbon capture. The carbonator may include a pressurized vessel with an inlet for fuel, air, and steam, and an outlet for syngas, and a draft tube surrounded by a fluidized bubbling bed of char. The char bed may be mounted on a distributor plate, into which are injected the air, steam needed to fluidize the char, and burn the char fines, and gasify the char. The flow to the draft tube may be essentially free of oxygen, in order to avoid the combustion of volatiles generated in said draft tube. The outlet of the draft tube may be immersed under a fluidized bed of char, which serves to thermally-crack the volatiles emitted from said draft tube.

The system for burning char may include a dust collector removing char fines from the syngas emerging from the carbonator, and an outlet for feeding char from the carbonator, if char in addition to the char fines are to be burned in a vessel other than the carbonator. The system may also include a cooler for cooling the char to a temperature at which they may be pulverized, a pulverizer for pulverizing the char, a subsystem for reducing the ash concentration from the stream of said fines to be used with high-ash coals, and a subsystem conveying said fines to a combustor. The combustor may be located within the carbonator if its function is to recover the heat from the char fines emitted from said carbonator. Some or all of the char may be used to produce char briquettes that replace the coal briquettes now used in developing countries for heating and cooking.

In accordance with still another exemplary embodiment, a system is provided for removing contaminants and pollutants from a syngas. The system includes a filter for preventing the clogging of the reactors used to remove halides from said syngas, a reactor for removing the halides in said syngas by a bed of sorbent in a fixed bed reactor, and a regenerable desulfurizer comprised of two circulating fluidized beds, one for a sorbent to remove the sulfur compounds from said syngas, and the second for regenerating said sorbent. The sulfur compounds in the gases emerging from said regenerator may be converted into a usable chemical such as sulfur or sulfuric acid. In the case of carbon capture, a second desulfurizing reactor is provided to remove trace amounts of sulfur compounds, and a barrier filter is provided to remove the particulate matter from the syngas. The system may be operated at a sufficiently-low temperature to: a. enable said filter to withstand the stresses and corrosion of its environment, b. enable the sorbent in said desulfurizers to remain unvaporized, and c. to enable the heavy metals, except mercury, to be condensed, with said condensate being collected by the filter downstream of said desulfurizers. The mercury in said coal is removed by post-combustion scrubbers ahead of the plant's stack.

In accordance with another exemplary embodiment, a system is provided for performing warm-gas cleanup of a syngas. The system includes internally-circulating fluidized beds to desulfurize said syngas and a moving-bed reactor to remove halides, in which char fines are removed by a classifier in a circuit that circulates said sorbent, thereby eliminating the need for the upstream filter in said warm-gas cleanup system.

In accordance with still another exemplary embodiment, a system is provided for reducing the carbon dioxide emissions from exhaust gases from an electricity generating plant. The system includes an adiabatic calcium looping system that incorporates the sorbent-enhanced reaction and steam methane reforming in a single reactor, or SE-SM, in which the active chemical in said sorbent is calcium oxide. The ACL system includes two reactors, one of which serves as a carbonator, and the other of which serves as a calciner. The ACL system may include two or more of each type of reactor, if needed to provide sufficient capacity for the system. The carbonator provides for sorbent-enhanced reaction, which converts syngas that contains the carbon in the fossil fuel, into a syngas with a much lower concentration of carbon compounds, which carbon is then contained in said sorbent. The carbonator may also be used to convert the methane in said syngas into carbon monoxide, which may then also be removed by said sorbent-enhanced reaction. The calciner regenerates said sorbent while emitting a stream of substantially pure carbon dioxide, that may then be compressed and stored in a manner that it doesn't re-enter the atmosphere.

The reactors include fixed beds of sorbent and catalyst, said catalyst being required to steam reform said methane. Just before the sorbent in any carbonator is saturated, the reactor serving as a carbonator is changed into a calciner, while said reactor that has been serving as a calciner, is converted into a carbonator, this changeover being provided by the opening and closing of valves controlling the flow of gases into and out of each reactor. Provision are made during the changeover to avoid excessive contamination of either said syngas or said stream of carbon dioxide emitted from said reactors.

In an exemplary embodiment, sorbent flows continuously through each reactor, or pairs of reactors, and is transferred between reactors, or pairs of reactors, by a transport mechanism.

### G. Alternative Carbon Capture Systems

Conventional carbon capture systems. FIG. 8 illustrates exemplary operating temperatures in the different reactors in conventional carbon capture systems, and exemplary operating temperatures in the different reactors in exemplary carbon capture systems. The temperature swings of the syngas in a conventional system 804 are much greater than those of exemplary embodiments, curve 802 on FIG. 8. In fact, the economic and efficiency penalties of the intermediate step of FIG. 8, of Methane reformer, is so severe that in an airblown IGCC, the carbon capture efficiency may be only 65%, using a conventional physical solvent process (MDEA). The conventional system may be unable to reach an approximately 90% carbon capture efficiency, in part because of the high methane concentration, and in part, because of the high steam consumption that would be required to achieve the higher number.

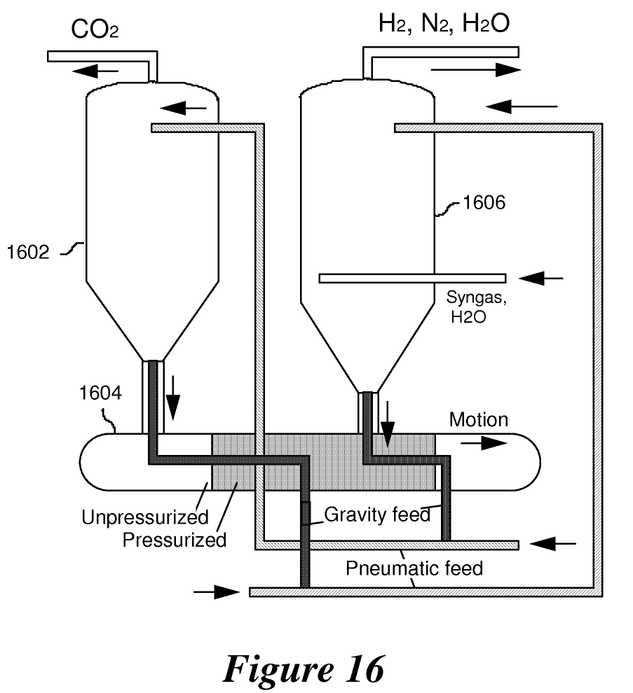

Moving-bed ACL. A moving-bed ACL has the same general arrangement as FIG. 1, including the use of two reactors, a compressor that places a vacuum on the calciner, and operates at the same conditions as those of FIG. 7. However, instead of the reactors changing their functions periodically, the sorbent is circulated around the reactors. Thus, the sorbent captures CO₂ in the carbonator 1606 and is continuously transported between the reactors by conveyor 1604 to the calciner 1602 for regeneration. FIG. 16 provides a simplified schematic diagram. Without the availability of composites, a moving-bed ACL would be an exemplary embodiment.

The principal disadvantages are high sorbent consumption, due to the fragile nature of the sorbent when subject to the turbulence of the fluidized beds, cyclone separators and/or pneumatic conveyors of moving bed systems. No attrition has been reported for stationary samples of sorbent subject to calcium looping, in contrast to attrition losses as high as 60% of the sample in as few as 20 cycles, have been reported for moving-bed systems. The mechanical conveyor, that has to transfer large amounts of sorbent (over 10,000 tons per hour, for a 330 MW plant) across high pressure differences (425 psia to 2 psia) and at high temperature (1500° F.) is also likely to have significant maintenance costs. The reactors are also twice as large, a large candle filter is provided ahead of the gas turbine, its volumetric flow rate increased by the high concentration of hydrogen in the syngas, and SE-SMR would be impractical, because of the high cost of the catalyst, which is also fragile.

Despite its costly conveyors and larger reactors, a cost study of an airblown IGCC using a moving-bed ACL was found to have a higher plant efficiency (about 38% versus about 35%) and approximately 7% lower cost of electricity (about 6.5¢/kWh versus about 7¢) compared with the same IGCC whose carbon capture was provided by a conventional (Selexol) system.

Temperature-swing calcium looping (TSCL). Calcium looping has been studied intensely for about a decade, as a hopeful alternative to other carbon capture systems. Virtually all of the work has been with temperature-swing calcium looping, by which the two reactors operate at different temperatures but the same pressure. The predominant applications have been stack-gas systems, operating at one atmosphere. Problems, compared with ACL, include very high thermal loads in the calciner—as much fuel may be needed as a third of the fuel to the entire power plant and heat that has to be recovered in the carbonator. Since the heat is used in the Rankine cycle, this reduces the power plant efficiency. Another difficulty is that oxygen is required to burn the fuel in the calciner, otherwise the nitrogen in the combustion air contaminates the CO2. Finally, attrition of the sorbent remains as a major problem.

### H. Comparison with Other Systems

Exemplary ACL systems cure deficiencies associated with conventional calcium looping system, called temperature-swing calcium looping (TSCL) in which fluidized-bed reactors cause high levels of particle attrition. Conventional TSCL systems also require the burning of significant amounts of fuel in the calciner and the removal of significant amounts of heat from the carbonator. These requirements reduce efficiency while increasing costs compared with ACL systems. TSCL systems also require the use of oxygen-blown gasification to avoid nitrogen contamination of the CO₂, further reducing plant efficiency and adding to the cost.

As the term is used here, a moving-bed system is one in which the sorbent is moved from one reactor to another reactor for the system to operate, and a fixed-bed system is one in which the sorbent is not moved from one reactor to another reactor for the system to operate. Fixed-bed reactors may be preferred to moving-bed systems for ACL in some exemplary embodiments, as well as with TSCL, because fixed-bed reactors eliminate sorbent attrition, which would otherwise be expected to add significantly to operating costs. Moving-bed ACL systems also require a material transfer system for moving very high quantities of solids across high pressure differences and at high temperatures. Such systems would be expected to require a high amount of maintenance. As such, exemplary ACL systems implement fixed bed reactors as an exemplary embodiment.

Other benefits of fixed-bed systems compared with the moving-bed systems include the elimination of a barrier filter downstream of the ACL system, which would be needed with a moving-bed system to remove attrition particles emitted by the carbonator. This filter is costly because of the high hydrogen concentration in the syngas that results in a high volumetric flow rates at the filter.

Additionally, if the sorbent becomes less reactive with time and needs to be reactivated by hydration, the period between such reactivations is increased by use of fixed-bed systems, because the time per cycle in fixed-bed systems is measured in minutes, instead of in the seconds in a moving-bed system.

Exemplary fixed-bed systems enable ACL to include SE-SMR, because there is no sorbent attrition in a stationary bed. SE-SMR is impractical in a moving-bed system, because the catalyst is fragile, which renders SE-SMR uneconomic because of the attrition in moving-bed systems.

Furthermore, exemplary fixed-bed reactors are typically considerably smaller and cheaper than reactors in moving-bed systems.

One of ordinary skill in the art will appreciate that the present invention is not limited to the specific exemplary embodiments described herein. Many alterations and modifications may be made by those having ordinary skill in the art without departing from the spirit and scope of the invention. Therefore, it must be expressly understood that the illustrated embodiments have been shown only for the purposes of example and should not be taken as limiting the invention, which is defined by the following claims. These claims are to be read as including what they set forth literally and also those equivalent elements which are insubstantially different, even though not identical in other respects to what is shown and described in the above illustrations.

What is claimed is:

1. An adiabatic calcium looping system for reducing carbon content in a syngas, the system comprising:
at least one fixed-bed reactor having a fixed sorbent bed, the at least one fixed-bed reactor alternately configured in a pressurized carbonator configuration and a sub-atmospheric pressure calciner configuration;
a calcium-based sorbent residing in the fixed sorbent bed for adsorbing the carbon in the syngas when the at least one fixed-bed reactor is configured in the carbonator configuration, and for desorbing the carbon when the at least one fixed-bed reactor is configured in the calciner configuration; and
one or more valve mechanisms for alternately configuring the at least one fixed-bed reactor in the carbonator configuration and the calciner configuration.

2. The system of claim 1, wherein the bed material of the at least one reactor includes a composite structure comprised of a coating and a substrate, the coating being comprised of the sorbent, and the substrate being either chemically inert with regard to carbon dioxide or having reduced reactivity with regard to carbon dioxide, wherein the ratio of the coating to the substrate is used to limit the temperature swing of the at least one fixed-bed reactor as it is cycled between the carbonator configuration and the calciner configuration.

3. The system of claim 2, wherein the bed material of the at least one reactor includes a catalyst used for steam reforming of methane.

4. The system of claim 3, wherein the composite structure includes the catalyst.

5. The system of claim 1, wherein the sorbent is provided as a composite structure in which a layer of the sorbent coats a substrate, the substrate being chemically inert or having a reduced reactivity with regard to carbon dioxide as compared to the reactivity of the sorbent with regard to carbon dioxide.

6. The system of claim 5, wherein the composite structure is in the form of one or more sorbent rods.

7. The system of claim 5, wherein the composite structure is in the form of pellets.

8. The system of claim 5, wherein the substrate absorbs heat generated during carbonation in the at least one fixed-bed reactor when the at least one fixed-bed reactor is configured in the carbonator configuration, and releases the heat to enable calcination in the at least one fixed-bed reactor when the at least one fixed-bed reactor is configured in the calciner configuration.

9. The system of claim 5, wherein the sorbent coating is comprised of a mixture of calcium oxide and calcium aluminate.

10. The system of claim 5, wherein the substrate is comprised of calcium aluminate.

11. The system of claim 5, wherein the sorbent coating is comprised of calcium oxide and the substrate is comprised of a dense cement.

12. The system of claim 11, wherein the cement is a calcium aluminate.

13. The system of claim 5, wherein the substrate is comprised of the same material as the sorbent coating, but wherein the substrate is rendered chemically inert with regard to carbon dioxide.

14. The system of claim 5, wherein the sorbent coating is attached onto the substrate using a brazing alloy.

15. The system of claim 1, further comprising:
one or more mechanical structures for supporting the sorbent to minimize the weight of the fixed bed bearing down on the sorbent.

16. The system of claim 15, wherein the one or more mechanical structures comprises:
tower packings disposed in the fixed bed.

17. The system of claim 15, wherein the one or more mechanical structures comprises:
one or more distributors configured to minimize the height of the bed.

18. The system of claim 1, wherein the fixed bed contains both the sorbent and a catalyst used to promote steam reforming of methane in the syngas.

19. The system of claim 1, wherein the one or more valve mechanisms configure the at least one fixed-bed reactor from the carbonator configuration to the calciner configuration when the sorbent in the fixed sorbent bed approaches or reaches a saturation level.

20. The system of claim 1, wherein the at least one fixed-bed reactors comprises:
a first fixed-bed reactor including a first fixed sorbent bed, the first reactor alternately configured in the carbonator configuration and the calciner configuration; and
a second fixed-bed reactor including a second fixed sorbent bed, the second reactor alternately configured in the calciner configuration and the carbonator configuration;
wherein the first reactor is configured in the carbonator configuration when the second reactor is configured in the calciner configuration, and the first reactor is configured in the calciner configuration when the second reactor is configured in the carbonator configuration.

21. The system of claim 20, wherein the one or more valve mechanisms configure the first and second reactors substantially simultaneously.

22. The system of claim 1, wherein the one or more valve mechanisms include one or more shutoff valves and one or more flow control valves.

23. The system of claim 1, wherein the at least one fixed-bed reactor is decompressed before changeover from the carbonator configuration to the calciner configuration.

24. A method of realizing a reduction in carbon dioxide emissions from an existing fossil-fuel power plant by upgrading or retrofitting the existing power plant to include a system in accordance with any one of the preceding claims.

25. The method of claim 24, wherein the existing fossil-fuel power plant is upgraded or retrofitted to include a hybrid integrated gasification combined cycle (IGCC) plant that implements low-cost carbon capture.

26. The method of claim 24, wherein the existing power plant is repowered to increase the generating capacity of the power plant.

27. The method of claim 24, wherein the fossil fuel is coal.
